(19) United States
(12) Patent Application Publication
(10) Pub. No.: US 2010/0186252 A1
(43) Pub. Date: Jul. 29, 2010

(54) FREEZE-DRYING METHOD AND APPARATUS

(75) Inventors: Shuji Morimoto, Osaka (JP); Yutaka Sakuma, Osaka (JP)

Correspondence Address: RANKIN, HILL & CLARK LLP, 38210 GLENN AVENUE, WILLOUGHBY, OH, 44094-7808, US

(73) Assignee: MORIMOTO-PHARMA CO., LTD., Osaka (JP)

(21) Appl. No.: 12/362,035

(22) Filed: Jan. 29, 2009

(51) Int. Cl. F26B 5/06; F26B 13/30

(52) U.S. Cl. 34/284; 34/92

(57) ABSTRACT

A freeze-drying apparatus comprises a vertical tube (2) and a spray device (4) for supplying liquid onto an inner surface of the vertical tube (2). Connected to the spray device (4) is a liquid-supply device (5) for supplying liquid material to be dried. The vertical tube (2) has a lower portion, to which a vertical guide cylinder (14) is connected. The guide cylinder (14) has a mid portion at which a roughly crushing device (15) and a first open-close valve (18) are arranged in order from above. The guide cylinder (14) has a portion above the first open-close valve (18), to which portion the liquid-supply device (5) is connected through a liquid-recovery passage (19) so as to recover excessive dried material to the liquid-supply device (5). The liquid-recovery passage (19) is additionally provided with a second open-close valve (20). A heating-freezing device (10) is disposed around the vertical tube (2) so as to control a temperature of the inner surface of the vertical tube (2). The vertical tube (2) is connected to a pressure-reduction device (12) in order that the vertical tube (2) can have its interior area vacuumed.

### BACKGROUND OF THE INVENTION

1. Technical Field

The present invention relates to a freeze-drying method which comprises freezing liquid material to be dried such as liquid medicine onto an inner surface of a vertical tube and then freeze-drying the frozen dried material and more particular concerns a freeze-drying method and apparatus able to roughly crush the freeze-dried product easily and besides readily handle the roughly crushed product as well as to be implemented at a low cost.

2. Background Art

A conventional example of the methods for effectively freeze-drying the liquid material to be dried such as aqueous solution of pharmaceutical comprises supplying the material to be dried onto an inner surface of a vertical tube and freezing it and freeze-drying the frozen dried material under vacuum (for example, see Patent Literature 1).

The conventional technique comprises a vertical tube, a spray means provided at an upper portion of the vertical tube, a liquid-supply means for supplying liquid material to be dried to the spray means, a liquid-recovery means connected to a lower portion of the vertical tube so as to recover excessive dried material, a freezing means arranged around the vertical tube so as to control a temperature of an inner surface of the vertical tube and a pressure-reduction means for converting an interior area of the vertical tube into vacuum state.

The liquid dried material supplied from the liquid-supply means is sprinkled and supplied onto the inner surface of the vertical tube by the spray means. The inner surface of the vertical tube is cooled by the freezing means to thereby freeze the dried material into a shape of pipe. At this time, the excessive dried material that has flowed down to the lower portion of the vertical tube is recovered to the liquid-supply means via a liquid-recovery passage. Then when a frozen layer of the dried material comes to a predetermined thickness, it stops the supply of the dried material from the liquid-supply means to reduce the pressure within the vertical tube and add sublimation heat, thereby enabling the frozen dried material to be freeze-dried.

The vertical tube has a lower end portion, to which a flange equipped with a nozzle is assembled. The flange incorporates a jet nozzle. If the dried material within the vertical tube is freeze-dried into the shape of pipe, it is scraped off the inner surface of the vertical tube, received by the flange with nozzle and roughly crushed by air injected out of the jet nozzle. The roughly crushed dried material is transported by the air to a jet mill to be crushed into more fine powder state. Thereafter, a cyclone device captures and collects the fine powder, which is recovered into a bulk can or the like.

[Patent Literature 1] Patent Application Laid-Open No. 2004-330130

### SUMMARY OF THE INVENTION

The conventional technique recovers the excessive dried material that has not been frozen, of the liquid dried material supplied into the vertical tube, from the lower portion of the vertical tube via the liquid-recovery passage. Thus the dried material can be used cyclically to result in improving efficiency. However, the pipe-shaped product freeze-dried within the vertical tube is roughly crushed with the air injected from the flange with nozzle. This causes the following problems:

(1) The freeze-dried product is roughly crushed with the air injected from the jet nozzle, thereby allowing a portion that is exposed to an air-jet stream to be easily converted to excessively fine powder. Further, in the case where the roughly crushed product obtained by rough crushing is crushed by the jet mil, the roughly crushed product is more easily converted to fine powder. If the freeze-dried product is converted to fine powder as such, powder dust feasibly occurs to make its handling or the like treatment uneasy. Besides there is caused a problem that it is not easy to fill a container such as a vial with a constant amount.

(2) The air injected from the jet nozzle must be discharged out of a system after it has roughly crushed the freeze-dried product. Therefore, it is not easy to separate the exhaust air from the roughly crushed product that has been roughly crushed and converted to fine powder. Particularly, in the event that the roughly crushed product is crushed by the jet mill, the obtained powder particles come to have a smaller diameter, which makes it more difficult to separate the powder particles from the exhaust air. Should part of the powder particles in the state of fine powder be contaminated into the exhaust air and discharged out of the system, it not only decreases the yield of the product but also causes a likelihood of dirtying and damaging the exo-system especially in the case of pharmaceuticals.

(3) The separation of the exhaust air from the powder particles necessitates a cyclone device, a bag filter or the like large-sized separating-collecting device. This causes a problem of enlarging whole the device and be unable to put it into practice at a low cost. In addition, it is not easy to ensure the separation of the fine powder particles from the exhaust air even if such a device is used.

The present invention has a technical object to solve the above-mentioned problems and provide a freeze-drying method and apparatus capable of easily crushing the freeze-dried product and besides readily handling the roughly crushed product as well as of being implemented at a low cost.

### [Means for Solving the Problem]

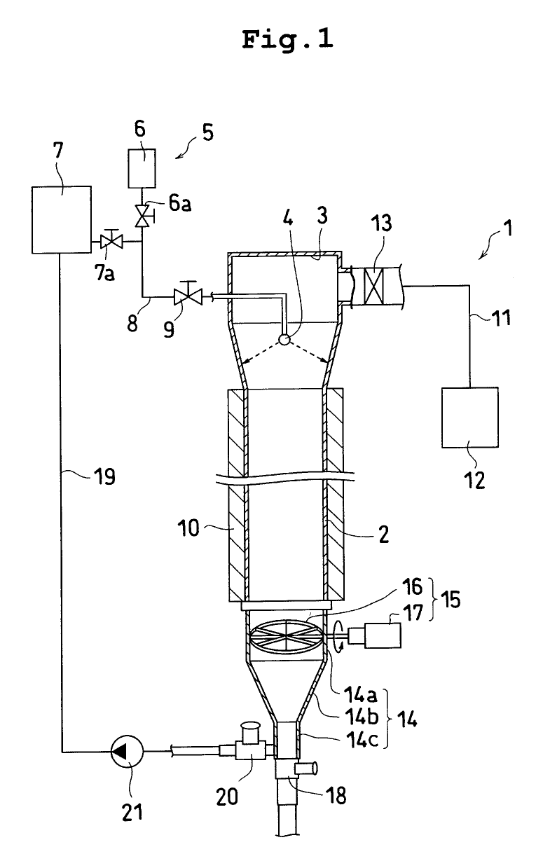

The present invention has been constructed as follows in order to solve the above problems, if it is explained based on FIGS. 1 to 5 which show embodiments of the present invention.

A first invention is directed to a freeze-drying method which comprises:

supplying liquid material to be dried, fed from a liquid-supply means (5) onto an inner surface of a vertical tube (2);

cooling the inner surface of the vertical tube (2) to freeze the liquid dried material into a pipe-shape and recovering excessive dried material that has flowed down to a lower portion of the vertical tube (2), to the liquid-supply means (5) via a liquid-recovery passage (19);

subsequently stopping the supply of the dried material from the liquid-supply means (5); and

then reducing the pressure within the vertical tube (2) to freeze-dry the frozen dried material, is characterized in that:

the vertical tube (2) has a lower portion to which a guide cylinder (14) is connected vertically, the guide cylinder (14) having a vertically mid portion provided with a roughly crushing means (15), to which the pipe-shaped product freeze-dried within the vertical tube (2) is guided and roughly crushed under the action of gravity, the obtained roughly crushed product being further guided toward a downstream side of the guide cylinder (14) also under the action of gravity.

A second invention concerns a freeze-drying apparatus which comprises a vertical tube (2), a spray means (4) for supplying liquid onto an inner surface of the vertical tube (2), a liquid-supply means (5) for supplying liquid material, which is to be dried, to the spray means (4), a liquid-recovery passage (19) connected to a lower portion of the vertical tube (2) and intended for recovering excessive dried material, a freezing means (10) arranged around the vertical tube (2) and intended for controlling a temperature of the inner surface of the vertical tube (2), and a pressure-reduction means (12) which puts an interior area of the vertical tube (2) into a state of vacuum, characterized in that:

the vertical tube (2) has a lower portion to which a guide cylinder (14) is connected vertically, this guide cylinder (14) having a mid portion at which a roughly crushing means (15) and a first open-close valve (18) are arranged in order from above, a liquid-recovery passage (19) being branched off between the roughly crushing means (15) and the first open-close valve (18) and being provided with a second open-close valve (20).

Here, the roughly crushing means may be, for example, a movable member that is movable within the guide cylinder or a fixed member such as a fixed blade projecting from an inner surface of the guide cylinder. Alternative it may be a combination of a movable member and a fixed member.

In the case where the roughly crushing means consists of the movable member, the pipe-shaped freeze-dried product is roughly crushed upon receipt of an impact given by the movement of the movable member during the guiding process under the action of gravity. It is to be noted that the movable member may reciprocally move or rotate within the guide cylinder. On the other hand, in the event that the roughly crushing means comprises a fixed member, the pipe-shaped freeze-dried product falls down under the action of gravity to collide with the fixed member to be crushed.

Although the vertical tube is not limited to those of a specific dimension, as the dried product freeze-dried within the vertical tube has a cross-sectional shape of a larger outer dimension, the more easily it is roughly crushed by the roughly crushing means. For this reason, the cross-sectional shape of the vertical tube has an inner dimension set preferably to at least 200 mm, more preferably to at least 300 mm, still more preferably to at least 400 mm. Here, the vertical tube has a cross section ordinarily shaped in a circle and the inner dimension refers to an inner diameter. However, the cross section may have a polygonal or any other shape. If the cross sectional shape is polygonal, the inner dimension refers to a length of a diagonal line.

The frozen thickness of the dried material freeze-dried into a pipe-shape within the vertical tube is sufficient if the freeze-dried product can be crushed by the roughly crushing means and therefore it is not limited to a specific one. However, as the frozen thickness is smaller, the more easily the freeze-dried product can be roughly crushed by the impact exerted while it is falling down. In consequence, it is preferably set to not more than 15 mm, more preferably to not more than 10 mm, and still more preferably to not more than 5 mm.

The roughly crushed product obtained by rough crushing of the roughly crushing means is contained by a container such as a bulk can arranged below the guide cylinder and then may be transported to a next step such as a crushing-granulating step. However, if a crushing-granulating means is connected to a lower end portion of the guide cylinder, the roughly crushed product is crushed and granulated to particles of a predetermined size through the crushing-granulating means, it is possible to perform the freeze-drying step through the crushing-granulating step by a series of devices and transport the roughly crushed product wastelessly under the action of gravity. Accordingly, this is preferable.

Further, in this case, if a powder filling means is connected to a portion below the crushing-granulating means and the powder particles obtained by granulating the roughly crushed product to a predetermined particle degree through the crushing-granulating means is arranged to be guided under the action of gravity to the powder filling means, it is possible to perform the freeze-drying step through the powder filling step by a series of devices and besides transport the roughly crushed product and the powder particles under the action of gravity to the filling step wastelessly. Therefore, this is more preferable.

Further, in the event that a mixing-feeding means is connected to a portion between the crushing-granulating means and the powder filling means and the powder particles granulated to a predetermined particle degree by the crushing and granulating means is arranged to be guided under the action of gravity from the crushing-granulating means to the powder filling means via the mixing-feeding means, it is possible to perform the freeze-drying step through the powder filling step by a series of devices, more uniformly mix the powder particles to be supplied to the powder filling means without being separated and besides transport the roughly crushed product and the powder particles under the action of gravity to the filling step wastelessly. Consequently, this is still more preferable.

It is to be noted that the freeze-drying step normally takes longer period of time than the crushing-granulating step. Thus the crushing-granulating means has an upper surface preferably connected to a plurality of vertical tubes through guide cylinders, respectively in view of the line balance.

### [Effect of the Invention]

The present invention is constituted and functions as mentioned above. It offers the following effects.

(1) The pipe-shaped freeze-dried product is roughly crushed by the roughly crushing means while it is being guided downwardly under the action of gravity within the guide cylinder. Therefore, differently from the rough crushing with the injected air according to the conventional technique, it is inhibited from being converted to excessively fine particles with the result of being able to readily execute the handling after the rough crushing or the constant-amount filling operation into a vial or the like container.

(2) Distinctly from the conventional technique, since there is no necessity of using the air injected from the jet nozzle, the roughly crushed product can be prevented from being discharged out of the system and as a result the yield can be kept high. Besides, the present invention dispenses with the separation of the exhaust air from the roughly crushed product conventionally required, so that it is no longer necessary to provide the large-sized separation-collection device such as the cyclone device and the bag filter with the result of being able to implement the invention at a low cost.

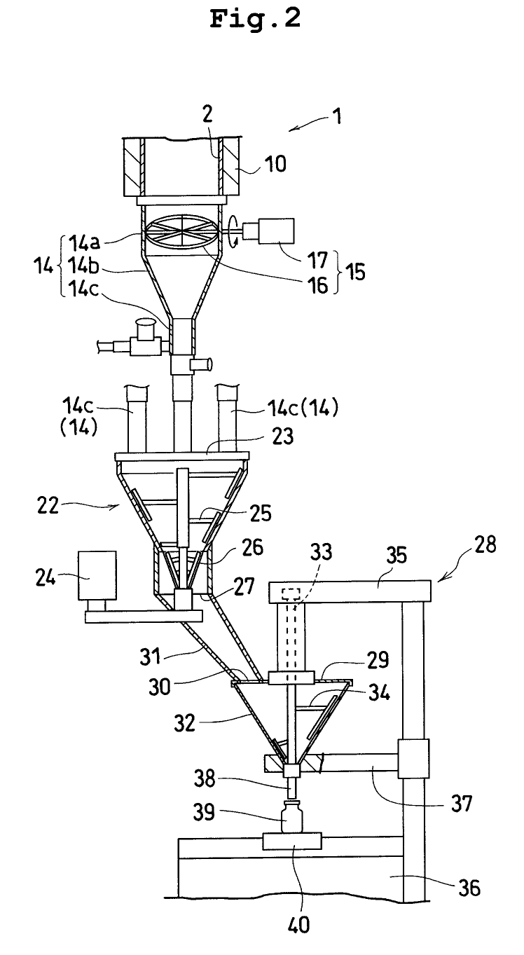

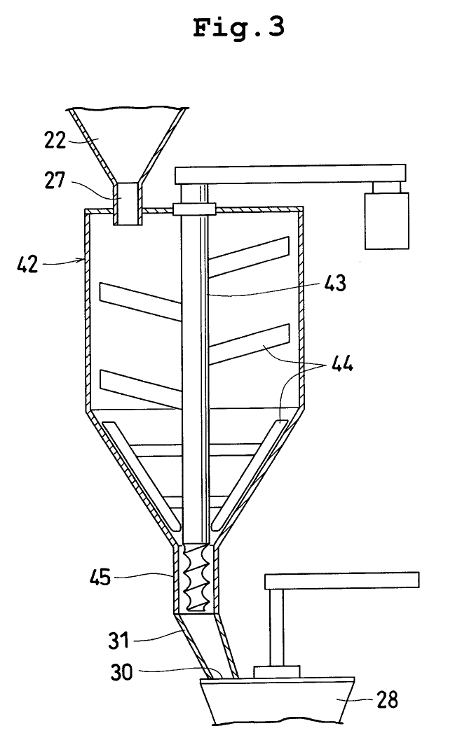

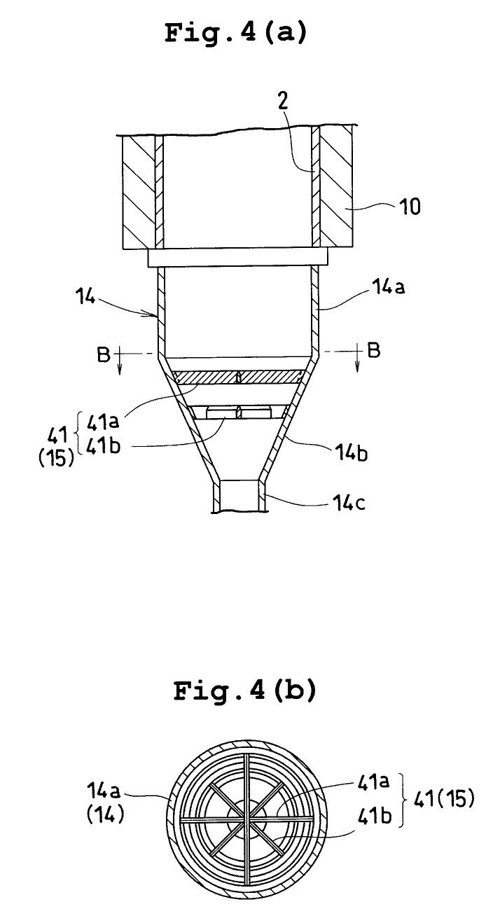

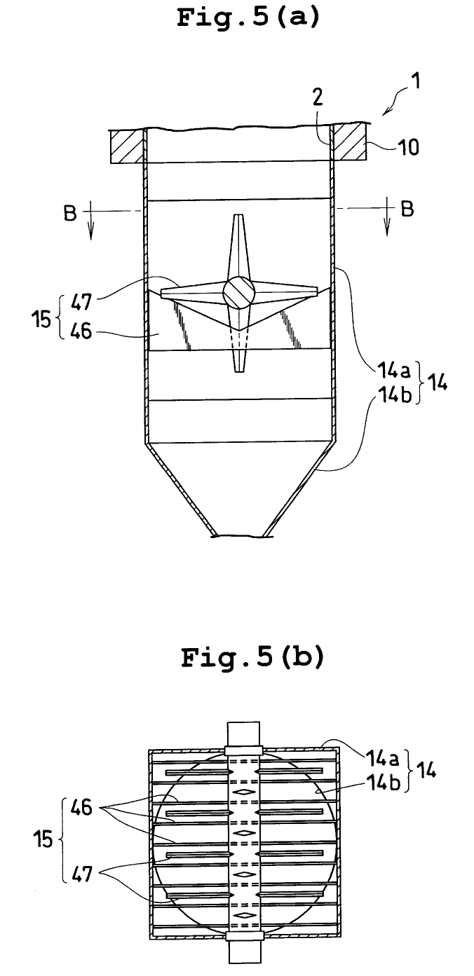

### BRIEF DESCRIPTION OF THE DRAWINGS

[FIG. 1] is a schematic structural view of a freeze-drying apparatus showing an embodiment of the present invention;

[FIG. 2] is a schematic structural view of a crushing-granulating device and a powder filling device connected to the freeze-drying apparatus of the first embodiment according to the present invention:

[FIG. 3] is a schematic structural view of a mixing-feeding device showing a second embodiment of the present invention;

[FIG. 4] shows a first modification of an embodiment according to the present invention. FIG. 4(a) is a view, in vertical section, showing the vicinity of the roughly crushing device and FIG. 4(b) is a sectional view when seen in a direction indicated by arrows along a line B-B in FIG. 4(a).

[FIG. 5] shows a second modification of an embodiment according to the present invention. FIG. 5(a) is a view, in vertical section, showing the vicinity of the roughly crushing device and FIG. 5(b) is a sectional view when seen in a direction indicated by arrows along a line B-B in FIG. 5(a).

### MOST PREFERRED EMBODIMENT OF THE INVENTION

Hereafter, an explanation is given for the embodiments of the present invention based on the drawings.

FIGS. 1 and 2 show a first embodiment of the present invention. FIG. 1 is a schematic structural view of a freeze-drying apparatus according to the present invention. FIG. 2 is a schematic structural view of a crushing-granulating device and a powder filling device connected to the freeze-drying apparatus.

As shown in FIG. 1, the freeze-drying apparatus (1) comprises a circular-cylindrical vertical tube (2), at an upper portion of which an air-tight chamber (3) is formed. Although this vertical tube (2) is not limited to a specific dimension, its inner diameter is formed to be, for example, at least 200 mm, preferably within a range of 300 mm to 600 mm, more preferably within a range of 400 mm to 600 mm. Further, the vertical tube (2) is formed to have a height of 500 mm to 4,000 mm, preferably 1,000 mm to 3,000 mm.

A spray device (4) is arranged within the air-tight chamber (3). The spray device (4) is connected to a purified-water tank (6) and a liquid-supply tank (7) via a liquid-supply passage (8). The liquid-supply tank (7) contains liquid material to be dried, for example, such as aqueous solution of pharmaceutical product. The liquid-supply passage (8) is additionally provided with a liquid-supply valve (9). This liquid-supply valve (9) and a take-out valve (6a) of the purified-water tank (6) are opened to supply the purified water to the spray device (4) from which the purified water is sprinkled within the air-tight chamber (3). This liquid-supply valve (9) and a take-out valve (7a) of the liquid-supply tank (7) are opened to feed the dried material to the spray device (4) from which the dried material is sprayed within the air-tight chamber (3).

A heating-freezing device (10) is arranged around the vertical tube (2). The vertical tube (2) has an inner surface controlled to a predetermined temperature lower than, for example, a freezing temperature of the dried material. The air-tight chamber (3) is connected to a pressure-reduction device (12) through a pressure-reduction passage (11), which is further provided with a pressure-reduction open-close valve (13). When the pressure-reduction open-close valve (13) is opened to drive the pressure-reduction device (12), the vertical tube (2) has its interior area vacuumed.

A vertical guide cylinder (14) is connected to a lower end portion of the vertical tube (2). The guide cylinder (14) comprises an upper portion (14a) of a larger diameter, a mid portion (14b) of a diameter decreasing progressively downwards, and a lower portion (14c) of a smaller diameter. A roughly crushing device (15) has a rotating blade (16) arranged within the larger-diameter portion (14a). The rotating blade (16) is rotated by a motor (17). Further, the smaller-diameter portion (14c) is additionally provided with a first open-close valve (18).

Further, it suffices if the decreasing diameter portion (14b) has an inner surface inclined to such an extent that the roughly crushed product does not stay. However, the closer to the vertical plane, the longer the vertical length. Accordingly, it is set to, for example, 60 degrees to 80 degrees, and more preferably 70 degrees to 80 degrees with respect to the horizontal plane.

Branched off above the first open-close valve (18) is a liquid-recovery passage (19), which is additionally provided with a second open-close valve (20) and a recovery pump (21). Connected to the liquid-recovery passage (19) is the liquid-supply tank (7), into which the excessive dried material that has flowed down within the vertical tube (2) is returned via the liquid-recovery passage (19) by the recovery pump (21).

As shown in FIG. 2, the guide cylinder (14) has a lower end connected to an upper cover (23) of a crushing-granulating device (22). The crushing-granulating device (22) has a crushing arm (25), which is rotated by a crushing motor (24) disposed in its inside portion and a screen (26) of a predetermined mesh additionally provided at its lower portion.

Further, three guide cylinders (14 . . . ) are connected to the upper cover (23). The vertical tube (2) is connected to an upper portion of each of the guide cylinders (14). However, the vertical tube (2) connected to the upper cover (23) in the present invention is set in number in view of a balance between the freeze-drying speed and the filling speed of a powder filling device to be mentioned later, and the number may be one or two, alternatively may be at least four.

The crushing-granulating device (22) has a take-out port (27) below which the powder filling device (28) is arranged. This powder filling device (28) has an upper cover (29) opened to provide a throw-in port (30). This throw-in port (30) and the take-out port (27) are connected to each other through a second guide cylinder (31). The powder filling device (28) includes a funnel (32) within which an auger screw (33) is disposed vertically. The auger screw (33) is additionally provided with an agitating blade (34). The auger screw (33) is supported by a support pedestal (36) through a support arm (35) and is intermittently driven for rotation by a transmission mechanism (not shown). The funnel (32) is supported by the support arm (35) and an auxiliary arm (37) disposed therebelow. This funnel (32) has a lower portion to which a metering portion (38) is additionally attached. A carry-in and carry-out portion (40) for vial or the like container is provided below the metering portion (38).

Next, an explanation is given for the operation procedures of the freeze-drying apparatus (1).

First, the vertical tube (2) has its inner surface cooled to below the freezing point by the heating-freezing device (10). With the pressure-reduction passage open-close valve (13) and the first open-close valve (18) closed, the take-out valve (6a) of the purified-water tank (6) and the liquid-supply valve (9) are opened, thereby enabling the purified water to be fed to the spray device (4) through which it is sprinkled within the air-tight chamber (3) and to flow down along the inner surface of the vertical tube (2) to freeze on the inner surface of the vertical tube (2).

When the frozen ice layer comes to have a thickness of, for example, about 2 mm, the take-out valve (6a) of the purified-water tank (6) is closed but the take-out valve (7a) of the liquid-supply tank (7) is opened. This allows the liquid dried material to be supplied from the liquid-supply tank (7) to the spray device (4) through which it is sprinkled within the air-tight chamber (3) and to freeze into a shape of pipe while flowing down along the inner surface of the vertical tube (2). At this time, the excessive dried material that has flowed down to the lower end of the vertical tube (2) within the latter, is recovered to the liquid-supply tank (7) through the second open-close valve (20) and the liquid-recovery passage (19).

If the frozen thickness of the dried material to be formed on the inner surface of the vertical tube (2) come to be a predetermined dimension, for example, about 10 to 15 mm, the take-out valve (7a) and the liquid-supply valve (9) are closed to stop sprinkling from the spray device (4). And after the excessive dried material has been recovered from the liquid-recovery passage (19) to the liquid-supply tank (7), the second open-close valve (20) is closed. Subsequently, the pressure-reduction open-close valve (13) is opened to drive the pressure-reduction device (12) so as to retain the interior area of the vertical tube (2) to a predetermined degree of vacuum. At the same time, the heating-freezing device (10) adds sublimation heat to the inner surface of the vertical tube (2), thereby enabling the frozen dried material to be freeze-dried.

After the freeze-drying procedures are completed, the frozen ice layer formed on the inner surface of the vertical tube (2) sublimates and disappears. Therefore, the freeze-dried product scrapes off the inner surface of the vertical tube (2) and falls down within the guide cylinder (14) to be received by the rotating blade (16) of the roughly crushing device (15).

Next, the pressure-reduction device (12) stops and the pressure-reduction passage open-close valve (13) is closed. Further, the first open-close valve (18) provided in the guide cylinder (14) is opened to return the interior area of the vertical tube (2) and that of the guide cylinder (14) to the atmospheric pressure. Then the motor (17) is driven to rotate the rotating blade (16), thereby applying an impact to the freeze-dried product for crushing the same. At this time, it suffices if the freeze-dried product is roughly crushed to a degree enough to pass through the lower smaller-diameter portion (14c) of the guide cylinder (14). The freeze-dried product need not be crushed to an excessively fine state.

The product roughly crushed by the rotating blade (16) passes through the decreasing-diameter portion (14b) and the smaller-diameter portion (14c) in order and is guided to the crushing-granulating device (22) under the action of gravity to be finely crushed by the crushing arm (25) and at the same time passes through the screen (26) to be granulated to a predetermined particle degree.

The particles granulated by the crushing-granulating device (22) are guided within the second guide cylinder (31) under the action of gravity and are thrown into the funnel (32) of the powder filling device (28). The particles are agitated by the agitating arm (34) within the funnel (32) and a predetermined amount of the particles is metered by the metering portion (38) at the lower end of the funnel (32) in correspondence with the rotation of the auger screw (33), sent out downwards from the metering portion (38) and filled into the predetermined container (39).

In the first embodiment, the crushing-granulating device (22) has its take-out port (27) directly connected to the throw-in port (30) of the powder filling device (28) through the second guide cylinder (31). However, according to the present invention, for examine, like a second embodiment shown in FIG. 3, a mixing-feeding device (42) may be connected to a portion between the crushing-granulating device (22) and the powder filling device (28).

The mixing-feeding device (42) comprises a vertical rotating shaft (43) and an agitating blade (44) attached thereto, provided in its interior area and an auger feeding portion (45) housing a screw, additionally provided at its lower portion. The crushing-granulating device (22) has the take-out port (27) connected to an upper surface of the mixing-feeding device (42) and the auger feeding portion (45) is connected to the throw-in port (30) of the powder filling device (28) through the second guide cylinder (31).

The powder particles granulated by the crushing-granulating device (22) is guided into the mixing-feeding device (42) where it is agitated through the agitating blade (44) and is uniformly mixed to result in preventing the separation by relying on the difference of the particle diameter. Then the thus uniformly mixed powder particles are guided from the auger feeding portion (45) to the throw-in port (30) of the powder filling device (28) via the second guide cylinder (31) under the action of gravity.

In the respective embodiments, an explanation is given for the case where the roughly crushing device (15) comprises the rotating blade (16) and the motor (17) for driving the rotating blade (16). However, according to the present invention, for example, like a first modification shown in FIG. 4, the roughly crushing device (15) may comprise a fixed blade (41) projecting from the inner surface of the guide cylinder (14).

More specifically, as shown in FIG. 4(a), the roughly crushing device (15) comprises fixed blades (41a, 41b) attached to the decreasing diameter portion (14b) at two vertical stages. Each of the fixed blades (41a, 41b) has an upper end formed in the shape of a cross. And as shown in FIG. 4(b), the fixed blade (41a) at the upper stage is staggered from the fixed blade (41b) at the lower stage by an angle of 45 degrees when seen in plan. Upon completion of the freeze-drying procedures, the freeze-dried product that has scraped off the vertical tube (2) and has fell down collides with the fixed blade (41) and is roughly crushed under the action of gravity. The roughly crushed product is guided downwards under the action of gravity within the guide cylinder (14).

Further, the roughly crushing device, like a second modification shown in FIG. 5, may comprise both of the rotating means and the fixing means. More specifically, the roughly crushing device (15) of the second modification comprises the guide cylinder (14), which has the upper portion (14a) of the larger diameter formed in the shape of a rectangular cylinder, a plurality of fixed blades (46) parallel to each other fixedly arranged within the larger-diameter portion (14a), and a rotating blade (47) passing through between the fixed blades (46). The freeze-dried product that has fell down from the vertical tube (2) of the freeze-drying apparatus (1) is crushed by the rotating blade (47) and the fixed blades (46) to become a roughly crushed product smaller than a gap between the fixed blades (46 . . . ) and be guided downwards from the decreasing diameter portion (14b) of the guide cylinder (14).

The freeze-drying apparatus explained in the respective embodiments as well as in the modifications are illustrated only for examples so as to embody the technical idea of the present invention. The shape and the dimension of each of the vertical tube and the guide cylinder are not limited to those of the embodiments as well as the structure, the shape, the arrangement and the like of each of the spray means, the liquid-supply means, the freezing means, the pressure-reduction means or the roughly crushing means. Various sorts of changes can be added to those ones as far as they fall within the scope of claims of the present invention. Needless to say, the frozen thickness of the dried material is not limited to a specific dimension.

In the above embodiments, purified water is fed prior to the supply of the dried material onto the inner surface of the vertical tube. Thus on completion of the freeze-drying procedure, the freeze-dried product scraps off the inner surface of the vertical tube and falls down. However, according to the present invention, if the freeze-dried product of the dried material easily scrapes off the inner surface of the vertical tube, it is possible to remove the formation of the frozen ice layer by the purified water.

In the respective embodiments and modification, the guide cylinder is arranged in a vertical direction, but so far as the roughly crushed product can fall down, it may be inclined with respect to the vertical direction.

Besides, in the respective embodiments and modifications, the crushing-granulating device, the mixing-feeding device and the powder filling device are disposed and connected to a portion below the freeze-drying apparatus. Needless to say, those devices are not to limited to ones that have the structure of each of the above embodiments. The freeze-drying apparatus of the present invention may have only the crushing-granulating means connected thereto or may omit its connection. In this case, it is possible to transport the roughly crushed product or the granulated powder particles by the bulk can or the like.

### INDUSTRIAL APPLICABILITY

The freeze-drying apparatus of the present invention can easily perform the rough crushing of the freeze-dried product and besides can readily handle the roughly crushed product as well as can be implemented at a low cost. In consequence, it is suitably used particularly for producing the freeze-dried powder of the pharmaceutical product and those in the other field.

### EXPLANATION OF NUMERALS

1 . . . freeze-drying apparatus
2 . . . vertical tube
4 . . . spray device (spray means)
5 . . . liquid-supply device (liquid-supply means)
10 . . . heating-freezing device (freezing means)
12 . . . pressure-reduction device (pressure-reduction means)
14 . . . guide cylinder
15 . . . crushing device (roughly crushing means)
16 . . . rotating blade (movable member)
18 . . . first open-close valve
19 . . . liquid-recovery passage
20 . . . second open-close valve
22 . . . crushing-granulating device (crushing-granulating means)
28 . . . powder filling device (powder filling means)
39 . . . container
41 . . . fixed blade (fixed member)
42 . . . mixing-feeding device (mixing-feeding means)
46 . . . fixed blade (fixed member)
47 . . . fixed blade (rotating member)

1. A method for freeze-drying a frozen material to be dried comprising:
supplying liquid material to be dried that has been fed from a liquid-supply means (5) onto an inner surface of a vertical tube (2);
cooling the inner surface of the vertical tube (2) to freeze the dried material into a shape of pipe and recovering excessive dried material that has flowed down to a lower portion of the vertical tube (2) to the liquid-supply means (5) via a liquid-recovery passage (19);
next stopping the supply of the dried material from the liquid-supply means (5); and
subsequently reducing the pressure within the vertical tube (2), wherein
a guide cylinder (14) is connected vertically to a lower portion of the vertical tube (2) and is provided at a vertical mid portion with a roughly crushing means (15),
the pipe-shaped product freeze-dried within the vertical tube (2) is guided under the action of gravity to the roughly crushing means (15) where it is roughly crushed, and
the obtained roughly crushed product is further guided under the action of gravity to a lower end side of the guide cylinder (14).

2. The freeze-drying method as set forth in claim 1, wherein
the roughly crushing means (15) comprises a movable member (16, 47) which is movable within the guide cylinder (14), and the freeze-dried product guided under the action of gravity is roughly crushed by applying an impact exerted by the movement of the movable member (16, 47).

3. The freeze-drying method as set forth in claim 1, wherein
the roughly crushing means (15) comprises a fixed member (41, 46) which projects from an inner surface of the guide cylinder (14), and the freeze-dried product is roughly crushed by colliding it with the fixed member (41, 46) under the action of gravity.

4. The freeze-drying method as set forth in claim 1, wherein
the dried material to be frozen into the pipe-shape within the vertical tube (2) is formed to have an outer dimension of at least 200 mm in cross section.

5. The freeze-drying method as set forth in claim 1, wherein
the dried material to be frozen into the pipe-shape within the vertical tube (2) has a frozen thickness of not more than 15 mm.

6. The freeze-drying method as set forth in claim 1, wherein
the guide cylinder (14) has a lower end portion additionally provided with a crushing-granulating means (22), to which the roughly crushed product obtained through rough crushing of the roughly crushing means (15) is guided under the action of gravity.

7. The freeze-drying method as set forth in claim 6, wherein
the crushing-granulating means (22) has a powder filling means (28) connected to a portion therebelow, to which powder particles granulated by the crushing-granulating means (22) is guided under the action of gravity.

8. The freeze-drying method as set forth in claim 7, wherein
there is connected to a portion between the crushing-granulating means (22) and the powder filling means (28), a mixing-feeding means (42), through which the powder particles are guided from the crushing-granulating means (42) to the powder filling means (28) under the action of gravity.

9. A freeze-drying apparatus comprising a vertical tube (2), a spray means (4) for supplying liquid onto an inner surface of the vertical tube (2), a liquid-supply means (5) for supplying liquid material to be dried to the spray means (4), a liquid-recovery passage (19) connected to a lower portion of the vertical tube (2) and intended for recovering excessive dried material, a freezing means (10) arranged around the vertical tube (2) so as to control a temperature of the inner surface of the vertical tube (2), and a pressure-reduction means (12) for vacuuming an interior area of the vertical tube (2), wherein
the vertical tube (2) has a lower portion to which a vertical guide cylinder (14) is connected, and the guide cylinder (14) has a mid portion at which a roughly crushing means (15) and a first open-close valve (18) are arranged in order from above, a liquid-recovery passage (19) being branched off between the roughly crushing means (15) and the first open-close valve (18) and being additionally provided with a second open-close valve (20).

10. The freeze-drying apparatus as set forth in claim 9, wherein
the roughly crushing means (15) comprises a movable member (10, 47) which is movable within the guide cylinder (14).

11. The freeze-drying apparatus as set forth in claim 9, wherein
the roughly crushing means (15) comprises a fixed member (41, 46) which projects from an inner surface of the guide cylinder (14).

12. The freeze-drying apparatus as set forth in claim 9, wherein
the vertical tube (2) is formed to have an inner dimension of at least 200 mm in cross section.

13. The freeze-drying apparatus as set forth in claim 9, wherein
the dried material formed on the inner surface of the vertical tube (2) has a frozen thickness of not more than 15 mm.

14. The freeze-drying apparatus as set forth in claim 9, wherein
the guide cylinder (14) has a crushing-granulating means (22) connected to a portion therebelow, which crushes and granulates the roughly crushed product obtained through rough crushing of the roughly crushing means (15) to particles of a predetermined size.

15. The freeze-drying apparatus as set forth in claim 14, wherein
the crushing-granulating means (22) has an upper surface, to which a plurality of vertical tubes (2 . . . ) are respectively connected through guide cylinders (14).

16. The freeze-drying apparatus as set forth in claim 14, wherein
the crushing-granulating means (22) has a powder filling means (28) connected to a portion therebelow, which fills into a predetermined container (39), the powder particles granulated by the crushing-granulating means (22).

17. The freeze-drying apparatus as set forth in claim 16, wherein
there is disposed between the crushing-granulating means (22) and the powder filling means (28) a mixing-feeding means (42) for agitating and mixing the powder particles.
